(19) United States
(12) Patent Application Publication
(10) Pub. No.: US 2008/0018077 A1
(43) Pub. Date: Jan. 24, 2008

(54) Boat trailer washing system

(76) Inventors: John Preece, Bonita Spring, FL (US); Chris Conn, Naples, FL (US)

Correspondence Address: John Preece, 27081 Flossmor Drive, Bonita Spring, FL, 34135, US

(21) Appl. No.: 11/491,659

(22) Filed: Jul. 24, 2006

(51) Int. Cl. B60P 3/10

(52) U.S. Cl. 280/414.1

(57) ABSTRACT

A boat trailer washing system is used after a trailer has been immersed in a body of water to cleanse the same from any salty residue which will easily and quickly have a detrimental effect on the structure of the trailer. The frame of the trailer has longitudinal water pipes installed thereon which carry a multiple of nozzles directed to the frame in one direction. The trailer hitch has a water tank mounted thereon which is the source of water for a pump located on the trailer. When the pump is activated, it will draw water from the water tank, pressurize the water and deliver the water under high pressure to the nozzles located on the water pipes. The water pipes may be rotated so that the water pressure may be directed to a hull of a boat located on the trailer.

### BACKGROUND OF THE INVENTION

It is common knowledge that boat trailers with a boat thereon are launched from a ramp once the trailer is backed into the water by the towing vehicle so that the boat on the trailer can be floated into the water. The same procedure takes place when the boat needs to be retrieved from an excursion, whereby the trailer is backed into the water and the boat is then floated back onto the trailer and fastened thereon. The problem is that the trailer after having been backed into water and pulled back out thereafter is coated with salt water which has a detrimental effect on its structure as well as on its wheels and its bearings. Therefore, it is important that the trailer frame be cleaned and washed after having been immersed in the water.

Therefore, this inventive concept will elevate the symptoms of rusting and mechanical failure by washing the trailer and frame every time the trailer has been immersed in water. This is accomplished by having a water pressure washing system located on the trailer that can be activated every time the trailer has been submerged. The washing system may include special nozzles to clean the bearings of the trailer. The washing system may include water pipes, which under water pressure, that can be rotated so that the trailer frame may washed or alternatively, the hull of the boat may be washed and cleaned either separately or simultaneously.

### BRIEF DESCRIPTION OF THE INVENTION

The inventive concept provides a washing system that is mounted on the boat frame, especially at the front the hitch, which is operated from the towing vehicle. The system includes water tank containing regular or clean water. After the trailer has been pulled out of the water, a switch is being activated from the towing vehicle that will start the pump to pressurize the system and to deliver washing water to the frame of the boat trailer as soon as the trailer leaves the salt water environment. As soon as the boat itself is retained on top of the trailer, the washing system may be activated to wash the trailer frame and the boat hull thereafter.

### BRIEF DESCRIPTION OF THE DRAWINGS

FIG. 1 shows a top view of the boat trailer including the location of the various spraying nozzles;

FIG. 2 is a side view of the boat trailer including the water lines and the spray nozzles;

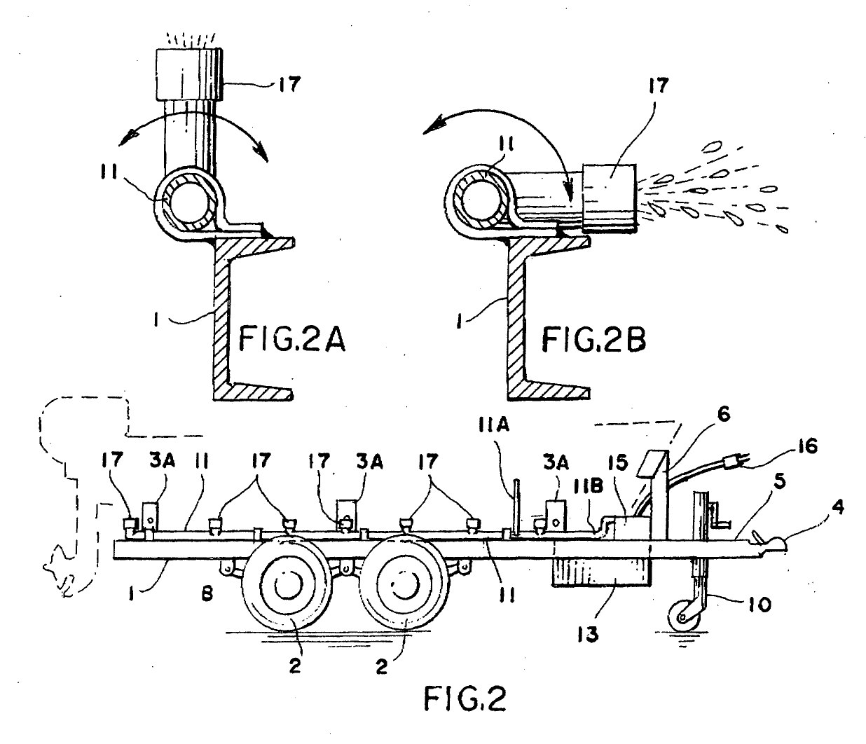

FIG. 3 shows the spray nozzles being directed to the wheels of the trailer.

### DETAILED DESCRIPTION OF THE INVENTION

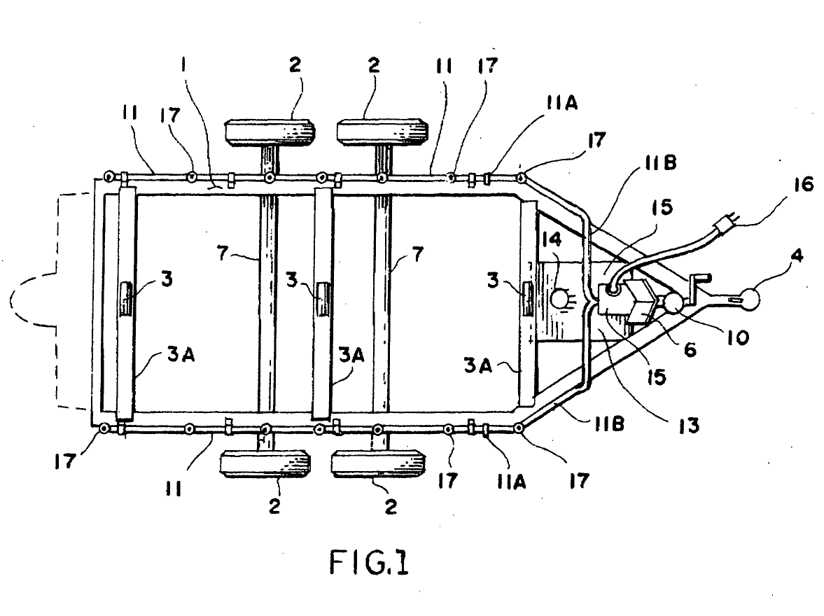

FIG. 1 shows the top view of the boat trailer frame 1 having the wheels 2 thereon. As is well known, the boat trailer has rollers 3 thereon to support the bottom of the boat hull when the boat is either moved onto or removed from the trailer by way of the rollers 3. Once the boat is received on the trailer, the supports 3a further support the boat while it is being transported. The front of the boat trailer has a hitch 5 that is being attached to a similar element on the towing vehicle. At the forward end of the boat trailer is a boat stop 6 that will limit the forward movement of the boat when it is being moved onto the trailer The boat trailer has may be one or two axles 7 to accommodate the conveyance of the boat. Each of the axles 7 are attached to springs 8 by way of shackles 9 which is well known in the art. The front of the boat trailer is supported by the wheel support when the occasion arises.

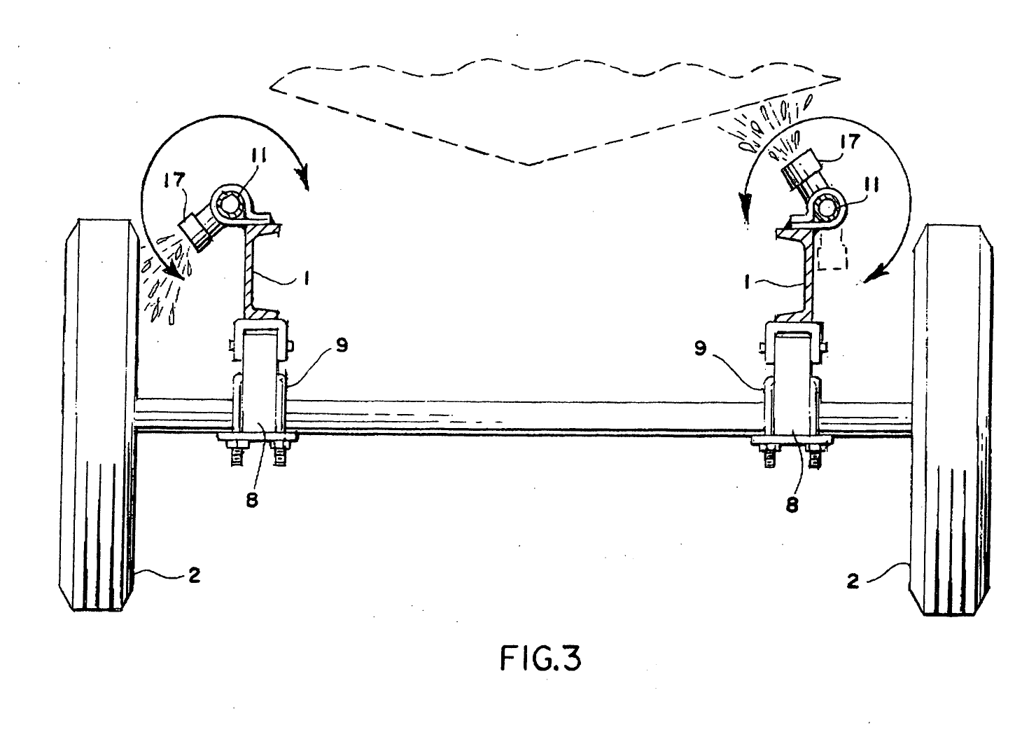

The inventive concept includes a water line 11 that will extend from the front of the trailer 1 to the rear. The water line is emanating from the front of the trailer by way of a water distributing line 12 which is connected to the water pump 15. The water to pressurize the system is derived form the water tank 13 which may be mounted at the front of the hitch 5. The water tank has a filler cap as is indicated at 14. The pump 15 is designed to deliver a pressure of water to up to at least 40/lbs/inch² to obtain the desired results of cleaning. The pump may be activated from the towing vehicle (not shown) by way of 12 Volts that is delivered to the pump by way of the electric line and plug 16. The water lines have incorporated therein a multiple of nozzles that are strategically located to wash the entire frame of the trailer after it has been immersed in salt water either temporarily or for an extended period of time. The object is to remove all salt residues frame the frame of the trailer including its wheels as is shown in FIG. 3. The water line 11 may be rotated throughout its length by way of rotating couplings so that the nozzles attached thereto may my used to wash either the trailer frame or the hull of the boat. FIG. 3 shows the nozzle 17 attached to the water line 11 being directed to the wheel 2 and its bearing. FIG. 3 also shows the nozzle 17 being directed to the opposite side of the frame 1 to wash that frame in that location including the spring assembly 8.

### Operation

When the trailer has been backed down a ramp into water and the boat has been floated the trailed frame including the wheels can be immediately by washed thereafter. A switch on the towing vehicle can be activated to pressurized the pump whereby the nozzle will be spraying the salt water off from the trailer to render it clean. In the reverse activity, once the boat has been retrieved from the water and secured on the trailer, again the trailer frame can be washed by the nozzle under pressure from the pump.

Thereafter, the longitudinal water pipes can be rotated so that the nozzles are directed toward the hull of the boat. The nozzles are now pressurized by way of the water pump and the hull of the boat can be washed.

What we claim is:

1. A boat trailer washing system comprising a basic trailer frame having a hitch to be attached to a towing vehicle, a water tank located on said trailer, a pump attached to said trailer and receiving water from said water tank when activated, longitudinal water pipes are located along said frame of said trailer, said water pipes having spray nozzles thereon, said nozzles deliver water under pressure to said frame in one position when said pump is activated to clean said frame.

2. The washing system of claim 1, wherein said nozzles deliver water under pressure to a hull of a boat located on said trailer when said nozzles are in another position.

3. The washing system of claim 1 including nozzles directing high pressure water to wheels and bearings of said trailer.

4. The washing system of claim 1, wherein said water tank and pump are placed on a hitch end of said trailer.

5. The washing system of claim 1 wherein electric power for said pump is derived from electric power of a towing vehicle.
